(19) United States
(12) Patent Application Publication
(10) Pub. No.: US 2010/0209645 A1
(43) Pub. Date: Aug. 19, 2010

(54) Water Based Intumescent Coating Formulation Especially Suitable For Structural Steel Components In Civil Engineering

(76) Inventors: Christopher Breen, Sheffield (GB); Simon Thompson, Sheffield (GB)

Correspondence Address: HOWARD & HOWARD ATTORNEYS PLLC, 450 West Fourth Street, Royal Oak, MI, 48067, US

(21) Appl. No.: 12/596,119

(22) PCT Filed: Apr. 16, 2008
(86) PCT No.: PCT/GB2008/001323

§ 371 Date: Mar. 19, 2010

(30) Foreign Application Priority Data
Apr. 18, 2007 (GB) GB0707463.6
Apr. 16, 2008 (GB) PCT/GB2008/001323

(51) Int. Cl. B32B 1/08; C09D 5/00; C09K 21/02

(52) U.S. Cl. 428/36.91; 106/287.17; 523/179; 106/18.12

(57) ABSTRACT

The present invention relates to an intumescent formulation comprising a clay such as an organoclay.

The present invention relates to an intumescent formulation comprising a clay such as an organoclay.

Steel is widely used in the construction industry. Exposed to heat, structural steel begins to soften at about 500° C. To allow occupants to safely evacuate or emergency services to safely enter a building during a fire, it is crucial to maximise the amount of time that a steel component can maintain its load bearing strength. The period of fire resistance required of fire resistant beams is generally specified in building regulations in terms of 30, 60, 90 or 120 minutes of fire protection (meaning that the beam will not fail for that period of time when exposed to a fire). For example, a steel structure of up to three floors may generally be required to have 60 minutes of fire protection before yielding.

One way to seek to achieve the desired longevity is by applying to the steel structure an intumescent coating (eg an intumescent paint). Such a coating thermally insulates the beam by producing a protective swollen organic char on the surface. An intumescent coating typically expands 50 to 100 times on exposure to heat and forms a heat resistant barrier which keeps the steel cool.

The present invention is based on the recognition that a clay has a synergistic benefit when present in an intumescent formulation. More particularly, the present invention seeks to improve the properties including the thermal barrier properties of an intumescent formulation by the inclusion of an amount of a clay such as an organoclay.

Thus viewed from one aspect the present invention provides an intumescent formulation comprising:
a source of carbon;
a blowing agent;
an acid source; and
a clay.

The presence of a clay such as an organoclay may give hitherto unrecognised synergistic benefits. For example, the formulation of the invention may advantageously improve the thermal barrier properties of a foamed intumescent coating leading to the use of thinner coatings. For example, a component coated with the formulation of the invention may exhibit 60 or more minutes of fire protection, possibly 90 or more minutes of fire protection or possibly even 120 minutes or more of fire protection. For example, if an intumescent formulation modified by the addition of a clay produces a higher char yield at a specified temperature, it may offer superior fire properties. Moreover the formulation of the invention may advantageously give a coating with increased scratch resistance (typically by one pencil hardness) and abrasion resistance so that painted steelwork is not damaged in transit or during erection and which provides a desirably stronger, more robust and more adhesive foamed char.

The clay may be a clay mineral (ie a natural unmodified clay) such as bentonite, hectorite or montmorillonite, a synthetic clay (eg a synthetic layered clay) such as hydrotalcite, fluormica or hectorite, an organoclay (eg a clay mineral as hereinbefore defined or synthetic clay modified by an organic material) or a mixture thereof.

Preferably the clay is a nanocomposite-forming clay (eg in a polymer dispersant).

In a preferred embodiment, the clay is an organoclay. An organoclay present in the formulation of the invention is typically a clay mineral which is physically or (preferably) chemically modified (eg at the surface) by an organomodifier. For example, a hydrophilic clay may be modified chemically by an organomodifier to be organophilic. The organomodifier may reside on either or both of the surface and the interlayer space (i.e. the gallery).

Preferred organomodifiers are alkylphosphonium or (preferably) alkylammonium ions (eg a tetraalkylammonium or tetraalkylphosphonium ion). In a preferred embodiment, the organomodifier is an optionally hydrogenated mono- or ditallow alkylphosphonium or alkylammonium ion which may be mono- or dihydroxylated.

Preferably the organomodifier is an ion of formula:

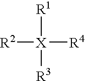

(wherein:

### X is P or N; and

each of R¹, R², R³ and R⁴ which are the same or different is hydrogen or an optionally substituted alkyl, alkenyl, alkoxyalkyl, carboxyalkyl or acyl derivative thereof, cycloalkyl, aryl or hydroxyalkyl group, or a polymer or co-polymer of at least one carboxylic acid or acyl derivative thereof).

The alkyl moiety in each group R¹, R², R³ and R⁴ may be independently long chain or short chain. The alkyl moiety in each group R¹, R², R³ and R⁴ may be independently a linear or branched C₁₋₃₆-alkyl moiety, preferably a linear or branched C₁₋₂₄-alkyl moiety, particularly preferably a linear or branched C₁₋₄₈-alkyl moiety.

Preferably one or more (eg one, two or three) of R¹, R², R³ and R⁴ is an alkyl group, particularly preferably a C₁₋₆-alkyl group (eg a methyl or butyl group) or a C₁₀₋₁₈-alkyl group (eg a decyl or hexadecyl group).

Preferably one or more (eg one or two) of R¹, R², R³ and R⁴ is a hydroxyalkyl group, particularly preferably a hydroxyC₁₋₆-alkyl group (eg a hydroxyethyl group).

Preferably one or more (eg one or two) of R¹, R², R³ and R⁴ is a polymer or co-polymer of at least one (preferably more than one) carboxylic acid or acyl derivative thereof. A preferred example is optionally hydrogenated tallow.

Suitable clays may be available from Souther Clay Products, Nanocor, Sud Chemie, Laviosa or Elementis.

A preferred clay is an organomodified montmorillonite (such as hexadecyltributylphosphonium exchanged montmorillonite or decyltrimethylammonium exchanged montmorillonite). A preferred clay is a synthetic hydrotalcite LDH (available from Sud Chemie). A preferred clay is a Cloisite (available from Southern Clay Products), particularly preferably organically modified Na-cloisite. Preferred organically modified Na-cloisites are Cloisite 6A, Cloisite 25A, Cloisite 30B, Cloisite 15A or Cloisite 10A, particularly preferably Cloisite 30B, Cloisite 15A or Cloisite 10A, more preferably Cloisite 10A.

A preferred clay is a mixture of Na-Cloisite and one or more of the group consisting of Cloisite 30B, Cloisite 15A and Cloisite 10A (preferably Cloisite 10A).

The organoclay may be commercially available or synthesised by methods available in the literature and familiar to those skilled in the art.

An effective amount of clay present in the formulation may be determined empirically. Typically the amount of clay is in the range 0.1 to 6.0 wt %, preferably 0.2 to 5.0 wt %, particularly preferably 0.25 to 2 wt %, more preferably 0.75 to 1.5 wt %, yet more preferably 0.5 to 1.25 wt %.

The blowing agent is preferably melamine or a nitrogeneous derivative or phosphorous-containing derivative or a mixture thereof. The melamine derivative may be a salt. Specific examples include melamine cyuranate, borate, formaldehyde, phosphate, tris-(hydroxyethyl) isocyanurate or polyphosphate. The blowing agent may be ammonium polyphosphate or chlorinated paraffin. The blowing agent may be present in an amount in the range 5 to 40 wt %.

The formulation may further comprise an inorganic char strengthening agent. The inorganic char strengthening agent may be selected from the group consisting of mineral wool fibres, glass flakes, an aluminosilicate (eg a potassium sodium alumina silicate such as nepheline syenite) or a ceramic material (eg a ceramic pigment). The inorganic char strengthening agent may be present in an amount in the range 1 to 9 wt %.

The source of carbon is a material (such as a compound (eg a salt or complex) or composition) capable of generating or decomposing or intumescing into char at an elevated temperature. The source of carbon is preferably present in an amount in the range 4 to 40 wt %.

The source of carbon may be an optionally mono- or poly-substituted long chain hydrocarbon, preferably a C₄₋₂₀-hydrocarbon, particularly preferably a C₅₋₁₂-hydrocarbon. The hydrocarbon is preferably branched. The hydrocarbon may be saturated or unsaturated. The hydrocarbon may be acyclic or cyclic. Optional substituents include hydroxyl or alkoxy groups.

A preferred source of carbon is one or more polyhydric alcohols or a derivative (including an alkoxy or ester derivative) thereof. The polyhydric alcohol may be a polyhydroxylated C₄₋₂₀-hydrocarbon, preferably a polyhydroxylated C₅₋₁₂-hydrocarbon. The polyhydroxylated hydrocarbon is preferably branched. Specifically preferred is pentaerithrytol or dipentaerithrytol or a mixture thereof, especially preferably pentaerithrytol.

The source of carbon may be cellulose acetate or starch.

The acid source may be an organic or inorganic acid salt such as a phosphate salt. Preferred are ammonium polyphosphate, melamine polyphosphate, magnesium sulphate and boric acid. The acid source may be present in an amount in the range 15 to 40 wt %.

The formulation may further comprise one or more additional components selected from the group consisting of a pigment, one or more polymeric or co-polymeric components (such as acrylic components), a resin binder, an initiator, a char promoter, a spumific agent, a catalyst, a nucleating agent, an anti-foaming agent, a viscosity modifier, a brightening agent (eg TiO₂), a plasticiser and a thixotrope.

A thixotrope such as an oil (eg hydrogenated castor oil) may be present in trace amounts eg 0.4 to 0.6 wt %.

A plasticiser such as a paraffin (eg a chlorinated paraffin) may be present in small amounts eg 2.8 to 5.6 wt %.

The polymeric components may be or comprise a long chain hydrocarbon polymer. The polymeric components may be or comprise acrylic components. The co-polymeric components may be or comprise vinylacetate and vinyl ester.

The nucleating agent may be an inorganic oxide such as titanium dioxide, zinc oxide, aluminium oxide, silica, silicates, cerium oxide, lanthanum oxide or zirconium oxide. Preferred is titanium dioxide. The nucleating agent may be present in an amount in the range 1 to 25 wt %.

The formulation of the invention may contain one or more solvents. The solvent may be water, butyl diglycolacetate, toluene or butanone. The solvent may be present in an amount in the range 15-60 wt %.

The solvent may be a non-aqueous solvent such as an organic solvent (which for example may be or comprise toluene or butanone).

In a preferred embodiment, the formulation is a water-based (eg aqueous) formulation. The formulation may contain a solvent which is an aqueous solvent or water. The addition of a clay such as an organoclay to a water-based formulation is a somewhat counter-intuitive step because this combination would be generally considered to be incompatible. Instead in this embodiment, the formulation may produce a stronger, more robust, more adhesive char with less tendency to slump.

In a preferred embodiment, the formulation is obtainable by adding an effective amount of a clay to a water-based intumescent composition.

In a preferred embodiment, the formulation is obtainable by adding an effective amount of a clay to FIRETEX M78 (available from Leigh's Paints (Bolton, UK)), FIRETEX FX5000 (available from Leigh's Paints (Bolton, UK)) or FIRETEX FX5002 (available from Leigh's Paints (Bolton, UK)) or a derivative or compositional equivalent thereof.

In a particularly preferred embodiment, the formulation is obtainable by adding an effective amount of a clay to FIRETEX FX5000 or FIRETEX FX5002 or a derivative or compositional equivalent thereof.

The formulation may be in the form of a resin (eg an acrylic resin), paint or emulsion. The formulation may be applied to a substrate as a coating by spraying or brushing.

The formulation is usefully applied to structural steel components such as a beam or girder in the form of an I-section, cellular section, tubular section or cylindrical section.

Viewed from a further aspect the present invention provides a structural component to which is applied a formulation as hereinbefore defined.

The presence of a clay in the formulation of the invention may lead to an improvement in the thermal barrier of the structural component (ie an extension of fire protection to higher temperatures on for example cylinders and I sections).

Preferably the structural component exhibits 30 or more minutes of fire protection, preferably 60 or more minutes of fire protection, particularly preferably 90 or more minutes of fire protection, most preferably 120 minutes or more of fire protection.

In a preferred embodiment, the structural component is a tubular section girder to which is applied a formulation obtainable by adding an effective amount of a clay to FIRETEX FX5000 or a derivative or compositional equivalent thereof.

In a preferred embodiment, the structural component is a tubular section girder to which is applied a formulation obtainable by adding an effective amount of a clay to FIRETEX FX5002 or a derivative or compositional equivalent thereof.

The formulation of the invention may significantly improve the usefulness of FIRETEX FX5002 in tubular sections.

In a preferred embodiment, the structural component is an I-section girder to which is applied a formulation obtainable by adding an effective amount of a clay to FIRETEX FX5002 or a derivative or compositional equivalent thereof.

The presence of a clay in the formulation of the invention may advantageously lead to extremely low slump on the I-section.

The invention will now be described in a non-limitative sense with reference to the following Examples and accompanying Figures in which:

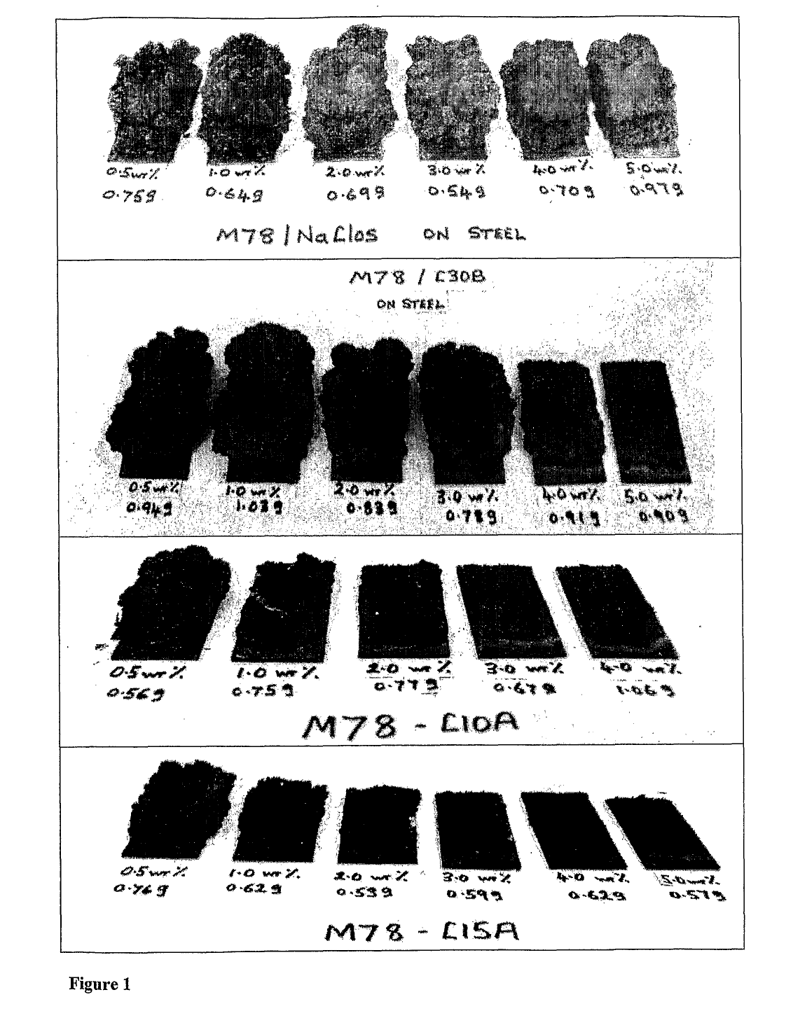

FIG. 1: Comparative char sizes (yields) for a selection of clay-containing M78 formulations. (The amount of organomodified clay added is expressed in wt % and the weight of the charred material is expressed in grams);

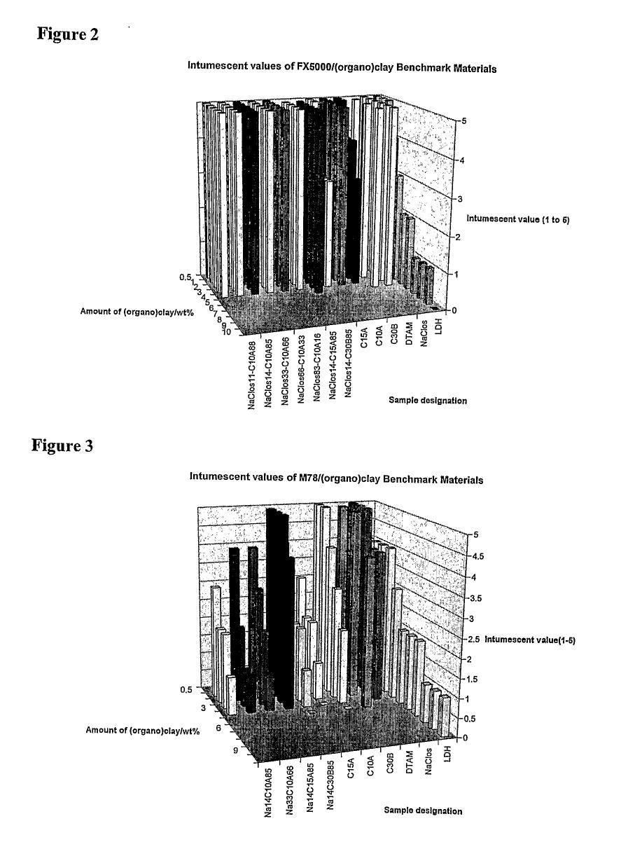

FIG. 2: Effect of the addition of LDH; organomodified clay and its mixtures with unmodified clay on the intumescent yield of samples prepared using the water-based paint, FX5000;

FIG. 3: Effect of the addition of LDH; organomodified clay and its mixtures with unmodified clay on the intumescent yield of samples prepared using the solvent-based paint, M78;

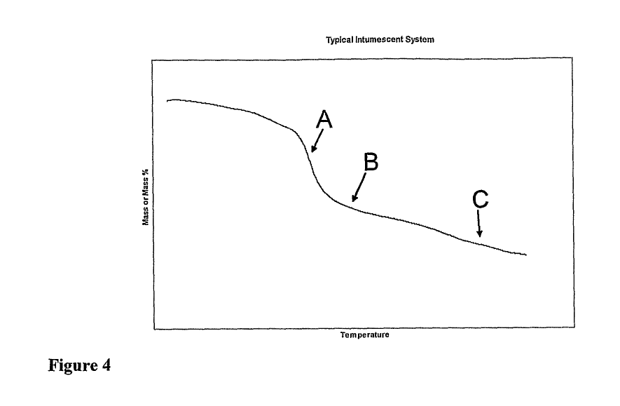

FIG. 4: Schematic TGA trace of a typical intumescent system;

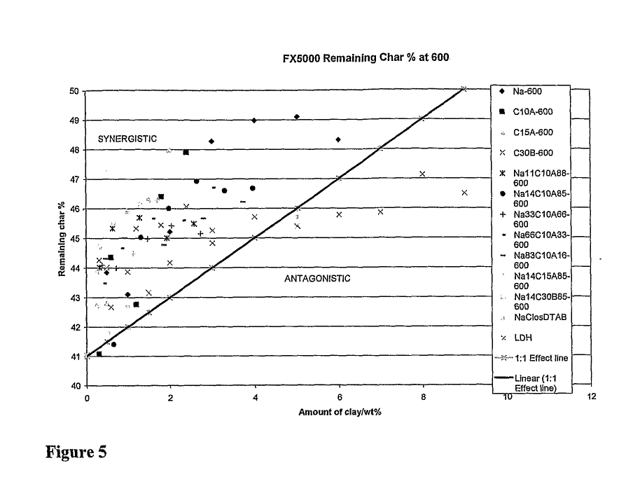

FIG. 5: Intumescent char yield at 600° C. (as determined from thermograms like that of FIG. 4) for samples prepared using the water-based paint, FX5000 (The diagonal line indicated the anticipated char yield if the clay did not enhance char formation);

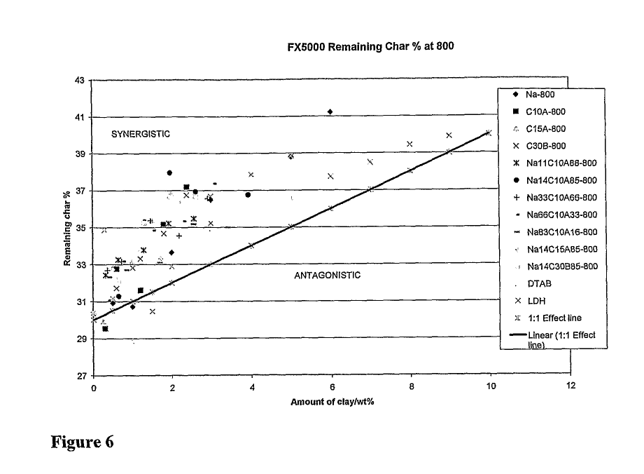

FIG. 6: Intumescent char yield at 800° C. (as determined from thermograms like that of FIG. 4) for samples prepared using the water-based paint, FX5000 (The diagonal line indicated the anticipated char yield if the clay did not enhance char formation);

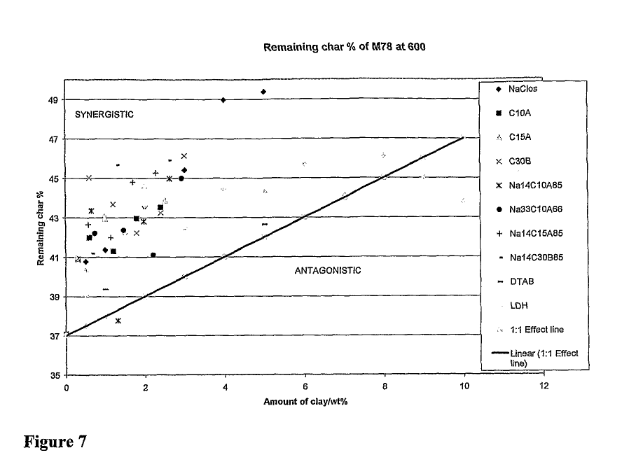

FIG. 7: Intumescent char yield at 600° C. (as determined from thermograms like that of FIG. 4) for samples prepared using the solvent-based paint, M78 (the diagonal line indicated the anticipated char yield if the clay did not enhance char formation);

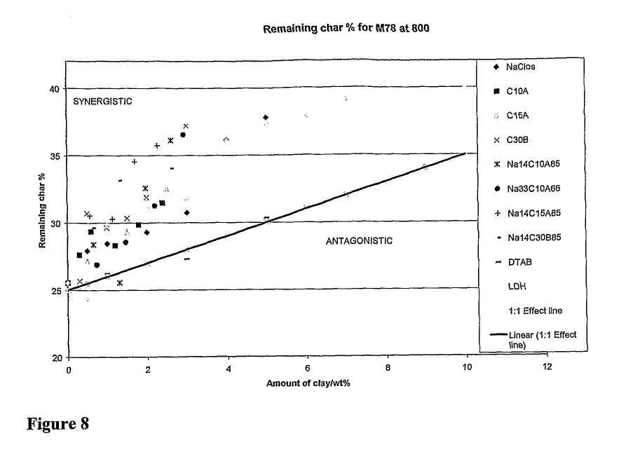

FIG. 8: Intumescent char yield at 800° C. (as determined from thermograms like that of FIG. 4) for samples prepared using the solvent-based paint, M78 (The diagonal line indicated the anticipated char yield if the clay did not enhance char formation);

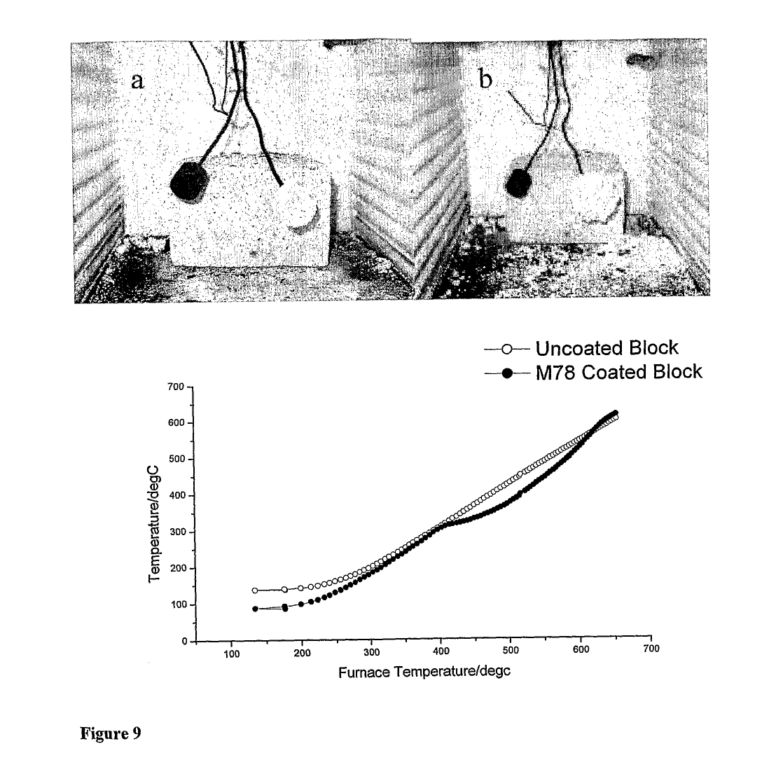

FIG. 9: Experimental set up for determining the thermal barrier offered by embodiments of the invention and a typical dataset obtained from the measuring thermocouples (the temperature of the blocks is plotted on the y-axis against the furnace temperature on the x-axis);

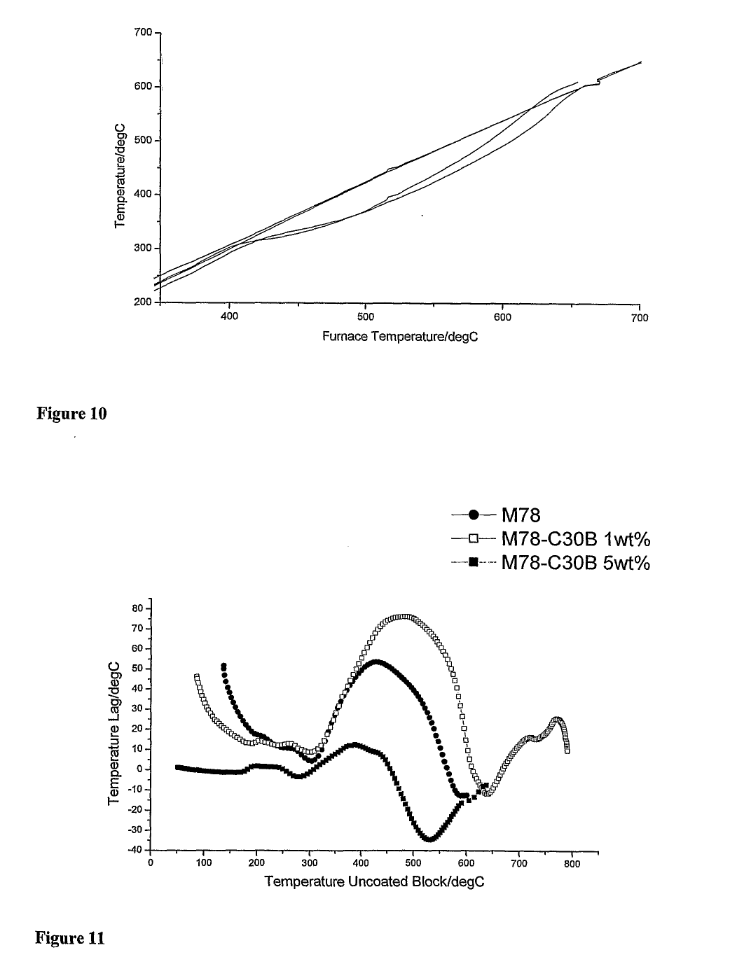

FIG. 10: A comparison of the thermocouple output from an uncoated block, a block coated with M78 alone and a block coated with organomodified clay-containing M78 (the temperature of the blocks is plotted on the y-axis against the furnace temperature on the x-axis. Note that the plots for the coated sample diverge near 520° C. and the clay containing coating extends the temperature lag to higher temperatures);

FIG. 11: Plots of temperature lag versus the temperature of the uncoated block. The open squares illustrate that adding 1 wt % C30B to M78 increases the maximum temperature lag and extends the useful temperature region to 600° C. compared with pure M78 (filled circles). In contrast, when 5 wt % C30B was added to M78 the coating was significantly worse than pure M78;

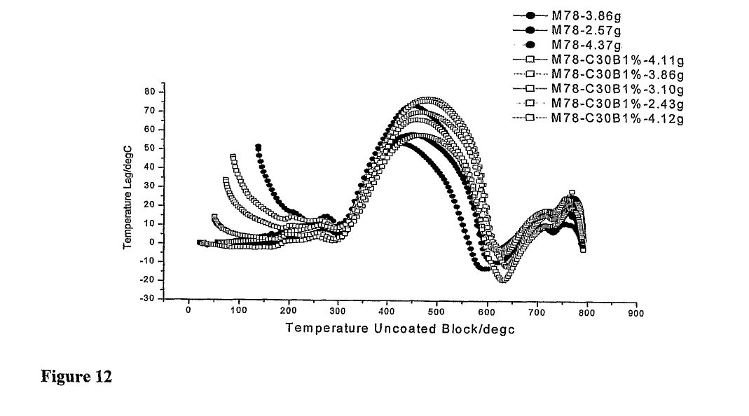

FIG. 12: The effect of coating weight on the temperature lag versus uncoated block temperature for pure M78 and M78 containing 1 wt % C30B;

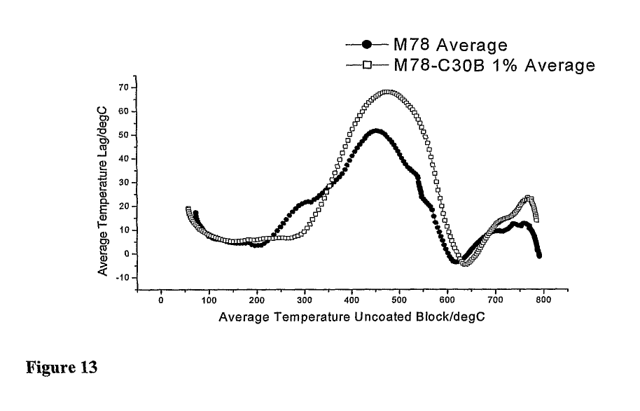

FIG. 13: The average temperature lag versus uncoated block temperature for pure M78 and M78 containing 1 wt % C30B. The datasets were the same as those used in FIG. 12;

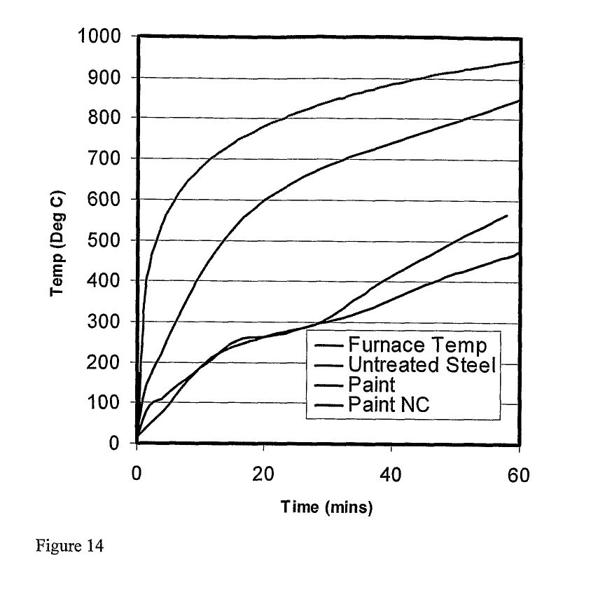

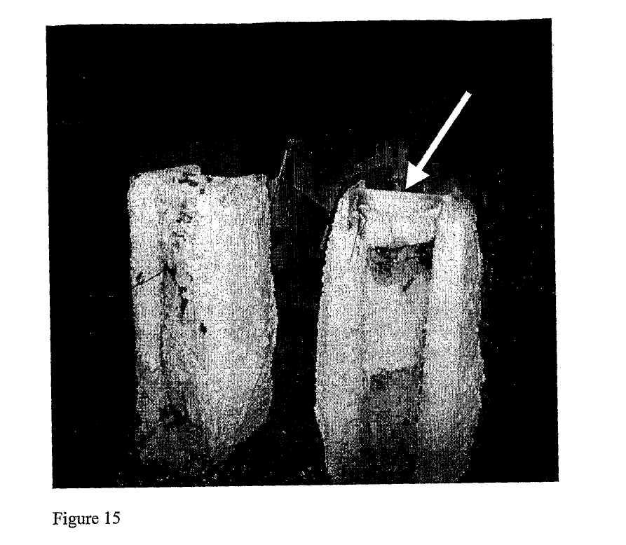

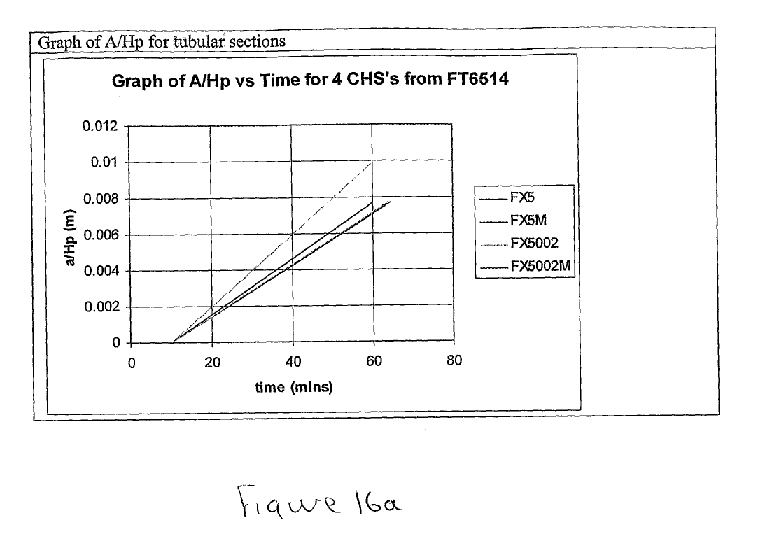

FIG. 14: The temperature versus time performance of a painted, hollow tube section; and

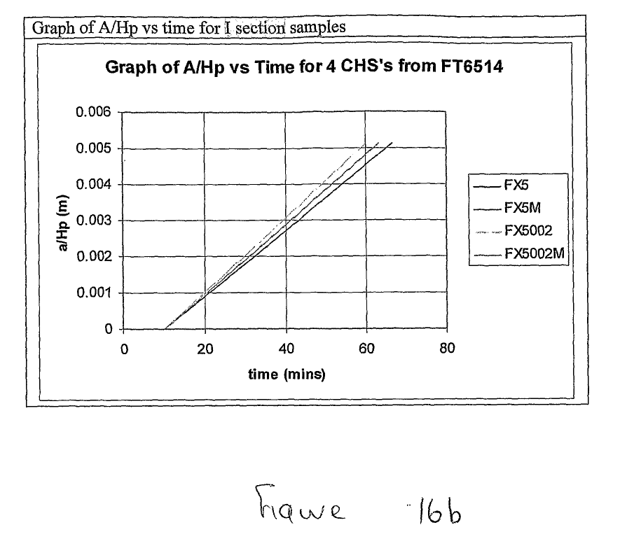

FIG. 15: Coated I sections after burning in a gas furnace (the section on the left is FX5002 containing the organomodified clay additive and the section on the right is pure FX5002).

### INTRODUCTION

Experiments were carried out to compare the thermal stability, degree of intumescence, thermal barrier properties, damage resistance and adhesion properties of benchmark coatings prepared with and without clay additives. The testing regime was carried out on a small scale laboratory basis.

### Materials

Although the majority of clay additives were commercially available, three bespoke clays were assessed. The clays included:

Na-cloisite—from Southern Clay Products
C30B—from Southern Clay Products
C10A—from Southern Clay Products
C15A—from Southern Clay Products
Bu16M—hexadecyltributylphosphonium exchanged montmorillonite (prepared using Na-cloisite)
Selected physical mixtures of the above clays
DTAM—Decyltrimethylammonium exchanged montmorillonite (prepared using Na-cloisite)
LDH from Sud Chemie
Benchmark paints were obtained from Leigh's Paints (Bolton, UK)
FX5000—a water-based proprietary paint
M78—a solvent-based proprietary paint
FX5002—a water-based proprietary paint (developed from FX5000)

The initial survey encompassed the preparation and characterisation of nanocomposite formulations based on the benchmark coatings. When the thermal barrier properties were assessed in the furnace trials, the study focussed on the M78 paint because preparation times and therefore sample turnaround times were much reduced.

### Method of Preparing Clays

20 g of clay was dispersed in 260 ml of deionised water in a 500 ml Pyrex beaker. To this was added approximately 2 mmol per gram (eg 9.39 g of tributylhexylphosphonium bromide, Aldrich) of the required salt. The suspension was distributed between 6 centrifuge tubes and centrifuged at 16500 rpm for 90 min; Sorvall RC6) and subsequently washed with deionised water (30 ml per centrifuge tube) before centrifuging. The modified clay was washed a minimum of five times but typically until the conductivity of the supernatant was <5 μS cm⁻¹. The resulting clay slurry was spread on a large Petri dish and dried for 16 hours at 50° C. The resulting powder was ground and then stored in sample vials until use. The clays were routinely characterised using x-ray diffraction and thermogravimetric analysis. Mixed clays were prepared by adding the required quantities of unmodified and modified clay to produce 20 g quantities (e.g. a 50:50 mixture would contain 10 g of each component).

### Addition of the Clay to Paints

In a typical experiment, sufficient organomodified clay was added to 40-60 mL of paint (in a waxed paper cup) to introduce 0.25 to 5 wt % of the organomodified clay. The organomodified clay was then stirred on a Dispermat mixer at 2500 rpm for 10 mins.

The paint was then applied to a glass or a steel coupon (8 cm×1.5 cm), a steel tubular rod (diameter of 2.5 cm and a length of 4 cm) or a steel rod of u-section (outer dimensions 10.0 cm×7.5 cm). Glass and steel coupons were introduced directly into an electrically heated furnace held at 500° C. The cylindrical or u-shaped steel rods were placed in the same electric furnace at room temperature and attached to a measuring thermocouple. An uncoated steel rod or u-section was used as a benchmark. The temperature of the oven was also monitored. In a typical experiment, the sample would be heated from room temperature to 800° C. over a period of 60 to 90 minutes.

The intumescent char yield of the painted steel coupons was assigned a number from 1 to 5 (where 5 represented no change in intumescent char volume and 1 indicated that there was little or no swelling of the paint film). In trials run in an industrial gas furnace, the preparation of the paint was scaled up to 6 litre quantities (in other words clay was added to 60 mL aliquots of paint so that there were no scale up problems). These were then applied using a brush to 0.5 m lengths of cylindrical tube of ca. 0.20 m diameter and I-section. When the paints were dry, the thickness of the film was measured and the results normalised to an average film thickness (DFT) of 1200 μm.

### Characterisation

The samples were characterised (i) using x-ray diffraction to determine the dispersion of the organomodified clays in the resin matrix, (ii) using thermogravimetry to study the thermal stability and the char yield of the nanocomposite formulation(s), (iii) in an oven at 500° C. to evaluate the influence of the organomodified clays on intumescent properties, (iv) by coating onto small stainless steel blocks and assessing their thermal barrier properties in an electric furnace and (v) in a 3 m×3 m×2 m gas fired furnace. The hardness of the coatings and their adhesion to the steel surface were also assessed.

### (1) Effect of the Addition of Organomodified Clay Addition on the Intumescent Yield of a Coating

The shape and volume of chars produced from clay containing M78 formulations are illustrated photographically in FIG. 1. The shape and volume together with the char weight (grams) were used to provide a numerical estimate of the char yield ranging from 5 (little different from clay free material) to 1 (greatly reduced char yield). The data for FX5000 and M78 is plotted in FIGS. 2 and 3 (where NaClos11-C10A88 denotes a physical mixture containing 11 wt % Na-cloisite and 88 wt % C10A and a similar identification method is used with other mixed samples of Na-cloisite and C30B and C15A).

A comparison of the photographs for M78/C30B in FIG. 1 with the corresponding numerical values presented in FIG. 3 is useful. It is clear from FIGS. 2 and 3 that the type and amount of added clay exerted a more profound effect on the char yield of samples derived from M78 than those derived from FX5000 where only the addition of LDH, C30B and C15A influenced the char yield. The addition of C15A and C10A had a particularly negative influence on the intumescent char yield of samples prepared using M78 whereas more C30B could be tolerated before the char yield was reduced.

### (2) Thermogravimetric (TG) Analysis of the Intumescent Formulations

TG analysis was used to quantitatively evaluate both the amount of material lost and the quantity of charred material remaining at a particular temperature. FIG. 4 presents a schematic illustration of a typical TG trace for an intumescent sample. The mass loss at low temperatures was attributed to the loss of solvent and surface oligomers. The formation of the intumescent shield occurred between points A and B. Between points B and C, a stable carbonaceous char exists. The mass of char remaining at 600 and 800° C. has been determined from curves such as these. The raw values were then adjusted to discount the weight contribution associated with the organomodifier. Using this approach it was possible to evaluate the amount of char developed per gram of inorganic clay added. These results are presented in FIGS. 5 and 6 for samples prepared using FX5000 and in FIGS. 7 and 8 for samples prepared using M78.

Most systems exhibited a char weight which exceeded that expected by the addition of clay ie a weight loss in excess of the weight of char from the resin plus the weight of clay confirming that the added clay was acting synergistically as a char promoter. The reverse of this behaviour (ie where clay addition reduces the char yield below that of the resin alone) is termed an antagonistic effect. The synergistic and antagonistic domains are clearly identified in FIGS. 5 to 8. There was no doubt that nearly all of the clays acted synergistically in the production of char. For example, the addition of 4 wt % Na-cloisite should (in the absence of a synergistic effect) only increase the char yield by 4 wt %. However the data in FIG. 7 shows that the char yield was double this value at 8 wt %. A similar assessment of the effect of C30B showed that the addition of 1 wt % of inorganic clay as C30B produced a char yield of 7 wt % in M78. (It is important to note that the TGA data does not distinguish between the formation of a dense char or a foamed char. Consequently, the TG data should not be interpreted in isolation).

### (2) Thermal Barrier Properties of the Clay-Containing Intumescent Formulations

Measuring thermocouples were inserted into an uncoated steel sample (the dark lozenge on the left of FIG. 9a) and a coated steel sample (the white lozenge on the right of FIG. 9b). The furnace was closed and the temperature increased from 100 to 800° C. at a steady rate.

FIG. 9b illustrates how the coating on the white lozenge foamed and oxidised back to a white colour at 800° C. The charred coatings can be seen to be dark grey after heating at 500° C. (FIG. 1).

The graphical data in FIG. 9 presents the temperature of the uncoated (white circles) and coated (dark circles) blocks as the furnace temperature increased. The two sets of temperature values were quite similar up to a furnace temperature of 420° C. At this point, the coated block reached the temperature at which the coating intumesced and after this point the temperature of the coated block lagged behind that of the uncoated block until the furnace temperature exceeded 600° C. At this point the thermal barrier properties of the coating collapsed and the temperatures of the coated and uncoated blocks became almost identical. Thus the difference between the temperatures of the coated and uncoated blocks is a measure of the barrier properties of the intumescent coating. The greater the difference the more efficient the heat shield offered by the intumescent char.

The data in FIG. 10 is almost identical to that in FIG. 9 except that the temperature of the M78 coating containing 1 wt % clay has been plotted. The effect of the addition of clay was immediately apparent. It was clear that both coatings began to intumesce near 420° C. because the temperature of the coated blocks began to lag behind that of the uncoated block as anticipated. However at 520° C. the temperature of the block coated with M78/clay then began to lag behind that of the block coated with pure M78. The veracity of this extended thermal lag was supported by repeated experiments and also by the thermogravimetric (and photographic) results which indicated the synergistically increased char yield when small amounts of clay were added to M78.

In order to accentuate the difference in the temperature lag behaviour exhibited by M78 containing different amounts of clay and/or different coat weights, the data is presented in a different way in FIGS. 11-13 where the y-axis displays the numerical difference between the temperature of the coated and uncoated blocks (ie Tcoated−Tuncoated) against the temperature of the uncoated block. In FIGS. 11-13, a successful clay-containing coating has a higher maximum value which extends to higher temperature than the data for M78 alone. An unsuccessful clay-containing coating exhibits a lower maximum temperature than M78 alone and may also return to the temperature of the uncoated block before pure M78.

The filled circles in FIG. 11 represent the temperature lag for a steel block coated with pure M78. The maximum temperature lag is 53° C. which occurs at an uncoated block temperature near 430° C. and the temperature of the coated block became equal to that of the uncoated block (ie temperature lag=0° C.) at 560° C. Addition of 1 wt % C30B to M78 increased the maximum temperature lag to 75° C. (an increase of 20° C.) and the temperature of the coated and uncoated blocks equalised at 610° C. (an increase of 50° C. compared to pure M78). In contrast, the data for the sample of M78 containing 5 wt % C30B only exhibited a maximum lag of 10° C. and returned to the temperature of the uncoated block at 460° C. ie 100° C. before pure M78. The veracity of these results was supported by the photographic record of the intumescent behaviour presented in FIG. 1 and the numerical representation presented in FIGS. 7 and 8 in that the intumescent yield of M78 containing 5 wt % C30B was extremely poor.

The data in FIG. 11 were selected to help describe the type of data collected and its interpretation. Nonetheless, the improved performance offered by adding small quantities of C30B was repeatedly tested because local variations in coating thickness, particularly at the edges, could result in lower values for the maximum lag difference and the temperature at which the coated and uncoated blocks became equal. The data presented in FIG. 12 illustrates this because there was noticeable variation in the performance values due to differences in coating weight of the pure and C30B containing M78 coatings. However, in general, the clay containing coatings (open squares, FIG. 12) displayed higher maximum temperatures and the temperatures of the coated and uncoated blocks became equal at higher temperatures compared with those for pure M78 (filled circles, FIG. 12).

The averaged data presented in FIG. 13 was used to minimise the influence of differences in coating thickness and coating weight in order to establish whether the trend suggested in FIGS. 11 and 12 was reproducible. The difference in the maximum temperature lag was still very evident but the temperatures of the coated and uncoated blocks became equal in the same temperature range.

Nonetheless, the intumescent yield values, the TG data and the thermal lag data all supported the view that the addition of 1 wt % C30B to M78 enhanced the performance of the coating. It is important to note that adding C10A was unsuccessful. Moreover, adding pure Na-cloisite did not improve the maximum temperature lag but there was some evidence of stabilisation of the coating to a higher temperature.

### (3) Damage Resistance and Adhesion of the Coatings

Adding clay to the M78 coatings significantly improved the adhesion of the coating. Indeed removing the coating in contact with the block required considerable abrasion. The ceramic nature of the char also increased as the clay content in the coating increased providing a more robust char. However, in most cases this coincided with a rather poor intumescent yield.

TABLE 1
The influence of clay type and loading on the scratch
resistance of M78.

Hardness values (H) at the
wt % clay loadings indicated

| Clay additive | 0.0 | 0.5 | 1.0 | 2.0 | 3.0 | 4.0 | 5.0 |
|---|---|---|---|---|---|---|---|
| Na-cloisite | 1H | 2H | 2H | 2H | 3H | 4H | 4H |
| C30B | 1H | 2H | 2H | 2H | 2H | 3H | 3H |
| C10A | 1H | 1H | 1H | 2H | 3H | 3H | 5H |
| C15A | 1H | 2H | 2H | 2H | 3H | 3H | 3H |
| DTA-CLAY | 1H | | HB | | 2H | | 3H |
| Na/C10A | 1H | 1H | 1H | 2H | 3H | 4H | 4H |
| LDH | 1H | — | HB | 1H | 1H | 1H | 2H |

Increasing the clay content in the coating produced a tougher, more scratch resistant coating. Visually this meant that the pure paints were easy to scratch and came away as a fine powder. The addition of clay to FX5000 and M78 resulted in coatings that were more scratch resistant. An attempt was made to quantify the increased in surface hardness by a standard method using pencils of different hardness. The data in Table 1 confirmed the qualitative assessment. In general, the addition of just 0.5 wt % clay (except for C10A) resulted in an increase of one pencil hardness. A further increase of one pencil hardness required the addition of at least 3 wt % of clay. Nonetheless, it was clear that the addition of very small quantities of clay did increase the surface hardness even though the M78 formulation contains an appreciable quantity of titanium dioxide.

### Fire Testing in an Industrial Gas Oven

FIG. 14 shows that adding the additive to a paint substantially decreased the rate of temperature increase compared with the paint alone. Moreover, the slope of the temperature versus time graph for the paint containing the additive is considerably lower. This opens up the possibility of a paint containing an organoclay additive being used to provide 90 minute or even 120 minutes fire protection. Emphasised in FIG. 15 is the fact that the pure coating has slumped away from the top of the 0.5 metre I section (right) whereas the paint containing the additive has not. This is a very significant observation because it means that the additive improves adhesion of the paint to the steel and thus prevents slumping.

FIGS. 16a and 16b (and Tables 2a and 2b below) compare the behaviour of FX5000 with a modifier (FX5000 modified) and without a modifier (FX5000) with the corresponding samples prepared using FX5002 (ie FX5002 modified and FX5002) on a tubular and I-beam respectively.

TABLE 2a
Summary of Pertinent Fire Test Data for Experiments using
Cylindrical Tube

| | | | | Normalised | Corr | Hp/A |
|---|---|---|---|---|---|---|
| | DFT | Time | DFT | Time | Time | Cut off |
| FX5000 | 1171 | 66 | 1170 | 65.9 | 60.0 | 130.0 |
| FX5002 | 1340 | 61.5 | 1170 | 53.7 | 48.9 | 101.0 |
| FX5000 Modified | 1135 | 68.75 | 1170 | 70.9 | 64.5 | 141.7 |
| FX5002 Modified | 1159 | 69.5 | 1170 | 70.2 | 63.8 | 140.0 |

TABLE 2b
Summary of Pertinent Fire Test Data for Experiments
using I-section Beam

| | | | | Normalised | Corr | Hp/A |
|---|---|---|---|---|---|---|
| | DFT | Time | DFT | Time | Time | Cut off |
| FX5000 | 1157 | 74 | 1120 | 71.6 | 60.0 | 195.0 |
| FX5002 | 797 | 68 | 720 | 61.4 | 60.0 | 195.0 |
| FX5000 Modified | 1112 | 79 | 1120 | 79.6 | 66.6 | 220.9 |
| FX5002 Modified | 720 | 64.75 | 720 | 64.8 | 63.2 | 207.6 |

Fire tests clearly showed that the additive did not enhance the performance of either M78 or FX5000 at the loading levels utilised. However, the additive did enhance the performance of FX5002—especially for tubular sections. The test was designed to evaluate 60 min fire protection.

There was also evidence that our additive may make FX5002 suitable for providing 90 and perhaps even 120 minutes of protection.

### SUMMARY

The results from the electric furnace can be summarised as follows:

The most important parameter which distinguishes between good and bad coatings is the difference between the temperature of an uncoated and a coated steel sample in a furnace as the temperature rises from 100 to 800° C.

(1) A clay-containing formulation of M78 which exhibits a greater maximum temperature lag than the clay-free formulation has been identified.
(2) This clay-containing coating protects the steel to a higher temperature than the clay-free formulation.
(3) The clay-containing formulation of M78 has a greater surface hardness than the clay-free formulation.
(4) The clay-containing formulation of M78 adheres more strongly to the steel sample.

Points (1) and (2) indicate good progress towards improvements in the thermal barrier leading to a thinner paint layer. Point (3) indicates good progress towards increased scratch and abrasion resistance. Point (4) indicates good progress towards a stronger more robust and more adhesive char.

The enhanced thermal barrier performance provided by adding just 1 wt % of the clay identified is attractive (so too is the extension of this capability by 50 to 100° C. to higher temperature). The observations regarding the greater adhesion are more difficult to quantify but the increased hardness of the coatings has been assessed using a standard industry method.

The results of the fired oven tests can be summarised as follows:
Note that FX5000 is considered to be the best in its class for 60 minutes fire protection of cylindrical hollow sections and that FX5002 is considered to be the best in its class for 60 minutes fire protection of I sections.
   (1) Modified FX5000 offers a 5% saving in film thickness compared with unmodified FX5000.
   (2) Addition of modifier substantially enhances the performance of FX5002 on cylindrical tube. Modified FX5002 offers a 5% saving in film thickness compared with FX5000 (best in class). Modified FX5002 offers a 27% improvement on unmodified FX5000. FX5002 may be commercially useful for I-section and cylindrical tube.
   (3) Addition of modifier improves moderately the capability of FX5000 on I-section (8% saving on film thickness compared with unmodified FX5000).
   (4) Addition of modifier to FX5002 offers a 5.4% reduction in film thickness compared with unmodified FX5002.
   (5) Addition of modifier to FX5002 reduces slumping on I-section offering better protection to higher temperatures such as may be 90 or even 120 minutes protection.

1. An intumescent formulation comprising:
a source of carbon;
a blowing agent;
an acid source; and
a clay.

2. A formulation as claimed in claim 1 wherein the clay is a clay mineral or a synthetic clay optionally modified by an organic material.

3. A formulation as claimed in claim 1 wherein the clay is bentonite, hectorite, montmorillonite, hydrotalcite, fluormica or hectorite optionally modified by an organic material or a mixture thereof.

4. A formulation as claimed in claim 1 wherein the clay is an organoclay.

5. A formulation as claimed in claim 4 wherein the organoclay is a clay mineral which is physically or chemically modified by an organomodifier.

6. A formulation as claimed in claim 5 wherein the organomodifier is an alkylphosphonium or alkylammonium species.

7. A formulation as claimed in claim 5 wherein the organomodifier is an optionally hydrogenated mono- or ditallow alkylphosphonium or alkylammonium ion which is optionally mono- or dihydroxylated.

8. A formulation as claimed in claim 5 wherein the organomodifier is an ion of formula: 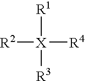
wherein:
X is P or N; and
each of R¹, R², R³ and R⁴, which are the same or different, is hydrogen or an optionally substituted alkyl, alkenyl, alkoxyalkyl, carboxyalkyl or acyl derivative thereof, cycloalkyl, aryl or hydroxyalkyl group, or a polymer or co-polymer of at least one carboxylic acid or acyl derivative thereof.

9. A formulation as claimed in claim 8 wherein one or more of R¹, R², R³ and R⁴ is a C₁₋₆-alkyl group or a C₁₀₋₁₈-alkyl group.

10. A formulation as claimed in claim 8 wherein one or more of R¹, R², R³ and R⁴ is a hydroxyC₁₋₆-alkyl group.

11. A formulation as claimed in claim 8 wherein one or more of R¹, R², R³ and R⁴ is a polymer or co-polymer of at least one carboxylic acid or acyl derivative thereof.

12. A formulation as claimed in claim 11 wherein one or more of R¹, R², R³ and R⁴ is optionally hydrogenated tallow.

13. A formulation as claimed in claim 1 wherein the clay is an organomodified montmorillonite.

14. A formulation as claimed in claim 1 wherein the clay is a synthetic hydrotalcite LDH.

15. A formulation as claimed in claim 1 wherein the clay is a Cloisite.

16. A formulation as claimed in claim 1 wherein the clay is an organically modified Na-cloisite.

17. A formulation as claimed in claim 1 wherein the clay is Cloisite 6A, Cloisite 25A, Cloisite 30B, Cloisite 15A or Cloisite 10A,

18. A formulation as claimed in claim 1 wherein the clay is Cloisite 30B, Cloisite 15A or Cloisite 10A.

19. A formulation as claimed in claim 1 wherein the clay is a mixture of Na-Cloisite and one or more of the group consisting of Cloisite 30B, Cloisite 15A and Cloisite 10A.

20. A formulation as claimed in claim 1 wherein the amount of clay is in the range of 0.1 to 6.0 wt %.

21. A formulation as claimed in claim 1 wherein the blowing agent is melamine or a nitrogeneous derivative or phosphorous-containing derivative or a mixture thereof.

22. A formulation as claimed in claim 1 further comprising an inorganic char strengthening agent.

23. A formulation as claimed in claim 1 wherein the source of carbon is a material capable of generating or decomposing or intumescing into char at an elevated temperature.

24. A formulation as claimed in claim 1 which is a water-based formulation.

25. A formulation as claimed in claim 1 obtainable by adding an effective amount of a clay to a water-based intumescent composition.

26. A formulation as claimed in claim 1 obtainable by adding an effective amount of a clay to FIRETEX M78, FIRETEX FX5000, or FIRETEX FX5002 or a derivative or compositional equivalent thereof.

27. (canceled)

28. A structural component to which is applied a formulation as defined in claim 1.

29. A structural component as claimed in claim 28 exhibiting 30 or more minutes of fire protection.

30. A structural component as claimed in claim 28 as a tubular section girder to which is applied a formulation obtainable by adding an effective amount of a clay to FIRETEX FX5000 or a derivative or compositional equivalent thereof.

31. A structural component as claimed in claim 28 as an I-section girder to which is applied a formulation obtainable by adding an effective amount of a clay to FIRETEX FX5002 or a derivative or compositional equivalent thereof.
